(19) United States
(12) Patent Application Publication
(10) Pub. No.: US 2025/0256246 A1
(43) Pub. Date: Aug. 14, 2025

(54) PARTICLE CAPTURE FILTRATION MEMBRANE, METHOD FOR MANUFACTURING THE SAME, AND METHOD FOR MEASURING PARTICLE COUNT

(71) Applicant: ORGANO CORPORATION, Tokyo (JP)

(72) Inventor: Tsukasa KONDO, Tokyo (JP)

(73) Assignee: ORGANO CORPORATION, Tokyo (JP)

(21) Appl. No.: 18/857,067

(22) PCT Filed: Feb. 28, 2023
(86) PCT No.: PCT/JP2023/007247

§ 371 Date: Oct. 15, 2024

(30) Foreign Application Priority Data
Apr. 22, 2022 (JP) 2022-070699

(51) Int. Cl. B01D 69/02; B01D 61/14; B01D 67/00; B01D 69/10

(52) U.S. Cl. CPC B01D 69/02; B01D 61/147; B01D 67/0065; B01D 67/0072; B01D 69/108; B01D 2325/02833; B01D 2325/04

(57) ABSTRACT

A particle capture filtration membrane includes: a base membrane with a first communication pore; and a skin layer formed on one surface of the base membrane, a second communication pore opening on the skin layer. The second communication pore connects to the first communication pore, and the channel diameter of the second communication pore is smaller than the pore diameter of the first communication pore connecting to the second communication pore.

### TECHNICAL FIELD

The present invention relates to measurement of particle count contained in a liquid, and, in particular, to a particle capture filtration membrane used for the measurement of the number of particles, a method for manufacturing the same, and a method for measuring the number of particles in a liquid using such a particle capture filtration membrane.

### BACKGROUND ART

Conventionally, membrane treatment, ion exchange treatment, decarbonation treatment or the like are conducted to remove various ionic components and water hardness components to produce pure water and ultrapure water. In particular, ultrapure water is used in applications such as the manufacture of semiconductor devices and the production of chemicals that require particularly low impurity levels. In recent years, ultrapure water used for these applications is required to have its particulate content reduced to a very low level, and further improvement in water quality is required. In the manufacture of semiconductor devices or the like, the number of fine particles in liquids other than ultrapure water, such as solvents and chemicals, must be also reduced to utmost limits. Therefore, it is necessary to measure the number of particles in the liquid in order to control its quality. The particle size of the fine particles to be controlled has been considered to be, for example, 10 nm or larger. There are several methods for measuring the number of particles in a liquid: one is to use scattering of laser light and another is to use sound waves. These methods enable on-line particle counting. However, it is extremely difficult to measure the number of particles on-line when particles with diameters of, for example, tens of nm or less are present at very low levels in, for example, ultrapure water.

The number of such particles in a liquid such as ultrapure water is measured by filtering the liquid using a filtration membrane with communication pores, i.e., micropores that penetrate through the filtration membrane, observing the particles remaining on the filtration surface after filtration with an observation device such as a scanning electron microscope (SEM), and counting the number of particles. In the following description, the filtration surface is the upstream surface of the two surfaces of the filtration membrane when liquid is permeated through the filtration membrane. The number of particles in a unit volume of liquid can be determined from the number of particles present in the area observed by the observation device and the amount of the liquid permeated. At this time, it is preferable to determine in advance the number of particles already present on the filtration surface (these particles are called blank particles) before passing the liquid through the filtration membrane, and to calculate the number of particles in the liquid after subtracting the number of blank particles from the number of particles present on the filtration surface after filtration.

According to such a method, if the shape of the communication pores is assumed to be roughly circular, and the pore diameter of the communication pores opening in the filtration membrane is, for example, 20 nm, the number of particles contained in the liquid with a particle diameter of roughly 20 nm or larger can be determined. Even if the shape of the communication pores at the topmost surface of the filtration surface is not circular, depending on the size of the communication pores, i.e., the area through which water can pass, fine particles can be trapped on the filtration surface, and the number of particles above a certain particle size contained in the liquid can be determined. The filtration membrane used to determine the number of particles or particle counts in the liquid in this method is also called a particle capture filtration membrane. In the particle capture filtration membrane, the communication pores having a pore diameter or size corresponding to the particle size of the particles to be counted must be provided. In addition, required for the particle capture filtration membrane is that the communication pores are distributed with an appropriate density of pores, the variation in pore diameter is small, liquid is allowed to pass through the filtration membrane quickly, the number of blank particles is small, mechanical strength is sufficient for preventing breakage during liquid filtration, and so on.

Materials used in the particle capture filtration membrane include: organic materials such as polymer membrane materials, for example, cellulose mixed esters, polycarbonate, and hydrophilic polyethersulfone; and inorganic materials such as aluminum oxide (i.e., alumina), silver, and copper. Alumina, which is formed by anodic oxidation of aluminum, is particularly suitable as a material for particle capture filtration membranes because the pore diameter can be easily controlled and the manufacturing process can be simplified.

In order to reduce the risk of dissolution of the particle capture filtration membrane when measuring the number of particles in ultrapure water, Patent Literature 1 discloses the formation of a very thin metal film containing at least one element selected from osmium (Os), tungsten (W), and titanium (Ti) on the surface of the filtration membrane by a chemical vapor deposition (CVD) method. The CVD method is used here because the entire filtration membrane must be covered with a metal film to protect the filtration membrane. This metal film, which is formed on the surface of the filtration membrane by the CVD method, is not intended to reduce the effective pore diameter of the communication pores in the filtration membrane.

In order to capture smaller particles, it is necessary to reduce the pore diameter of the communication pores in the filtration membrane or the individual areas through which water can pass, which in turn reduces the flow rate of water permeated through the filtration membrane. Reduction in the amount of permeated water means that the time to filter the volume of water which is needed to measure the particle counts is prolonged. In order to solve such a problem, Patent Literatures 2 and 3 disclose that the filtration membrane is formed in a multi-stage configuration in which the pore diameter of the communication pores is varied in stages along the thickness direction, and the surface on which the end of the communication pore with the smaller pore diameter opens is used as the filtration surface.

The particle capture filtration membrane disclosed in Patent Literature 2 is a filtration membrane which is formed by anodizing an aluminum material to form communication pores, and which includes: a small pore diameter part with communication pores formed to open one surface of the filtration membrane, i.e., the filtration surface; an intermediate pore part with communication pores to which a plurality of the communication pores of the small pore diameter part are connected and which have a larger diameter than the diameter of each of the communication pores in the small pore diameter part; and a large pore diameter part with communication pores to which a plurality of the communication pores of the intermediate pore part are connected, and which have a larger diameter than the diameter of each of the communication pores in the intermediate pore part and are formed to open to the other surface of the filtration membrane. In the small pore diameter part, the communication pores having an average pore diameter of 4 to 20 nm are provided up to a position of at least 400 nm from the one surface of the filtration membrane. The total membrane thickness of the filtration membrane is less than 50 μm. The particle capture filtration membrane disclosed in Patent Literature 3 is a filtration membrane as described in Patent Literature 2, which is characterized in that the pore diameter of the communication pores in the large pore diameter part is narrower on the intermediate pore part side than on the other surface of the filtration membrane.

In addition, Patent Literature 4 discloses a method of forming a thin film on a surface of a porous material by the CVD or physical vapor deposition (PVD) method as a method of reducing the pore diameter of fine pores in the porous material obtained by compressing and sintering ceramic or metal powders. The fine pores formed in the porous material by sintering have a pore diameter of 100 nm or more and are highly variable, and it is difficult to make communication pores having a multi-stage structure as described above. Therefore, even if the method described in Patent Literature 4 is applied to a film obtained by anodizing aluminum in a general way, it is not possible to obtain a particle capture filtration membrane with a good quality that can be used to measure the particle counts.

As a method to reduce the number of blank particles remaining on the filtration surface of a particle capture filtration membrane, Patent Literature 5 discloses washing the filtration membrane using functional water obtained by dissolving hydrogen gas in ultrapure water and further adding alkaline chemicals.

### CITATION LIST

### Patent Literatures

Patent Literature 1: JP 2021-130073 A
Patent Literature 2: JP 2016-64374 A
Patent Literature 3: WO 2017/154769 A1
Patent Literature 4: JP S62-270473 A
Patent Literature 5: JP H11-165049 A

### SUMMARY OF INVENTION

### Technical Problem

In recent years, miniaturization of semiconductor devices has progressed significantly, and the number of particles in various liquids used in the manufacture of semiconductor devices has become more limited. Therefore, with regard to ultrapure water, it is increasingly required to be able to control the number of fine particles, for example, those with a particle diameter of 5 nm. In order to control the number of particles in ultrapure water, it is necessary to be able to measure the number of the particles to be controlled. The particle capture filtration membranes disclosed in Patent Literatures 2 and 3 can be used to measure the number of fine particles with a particle diameter of 5 nm or larger, because the pore diameter of the communication pores at the filtration surface can be as small as 4 nm. However, when forming filtration membranes by anodizing aluminum material, it requires advanced technology to reduce the pore diameter of the communication pores to 10 nm or less, and the yield rate when manufacturing filtration membranes is low. The particle capture filtration membranes disclosed in Patent Literatures 2 and 3 also have a problem in that the portion of communication pores formed as a small pore diameter part is long in a thickness direction, and when the pore diameter of the communication pores in the small pore diameter part is small, the amount of water permeated becomes small. Therefore, it is not easy to measure the number of particles in a liquid that have a particle size of 10 nm or less when using the particle capture filtration membranes described in Patent Literatures 2 and 3.

The object of the present invention is to provide: a particle capture filtration membrane in which the size of each of individual areas allowing water to permeate is, for example, less than 10 nm at the topmost surface of the filtration surface, and which can be produced in high yield; a method for producing the same; and a method for measuring the number of particles in a liquid using such a particle capture filtration membrane.

### Solution to Problem

According to an aspect of the present invention, the particle capture filtration membrane with a communication pore that allow liquid to permeate through includes: a base membrane with a first communication pore; and a skin layer which is formed on one surface of the base membrane and in which a second communication pore is formed, wherein the second communication pore is connected to the first communication pore, and wherein a channel diameter of the second communication pore is smaller than a pore diameter of the first communication pore that is connected to the second communication pore.

According to an aspect of the present invention, the manufacturing method of a particle capture filtration membrane with a communication pore allowing liquid to permeate through includes a step of forming a skin layer by physical vapor deposition on one surface of a base membrane with a first communication pore, wherein the skin layer is equipped with a second communication pore that is connected to the first communication pore, and a channel diameter of the second communication pore is smaller than a pore diameter of the first communication pore that is connected to the second communication pore.

According to an aspect of the present invention, the measurement method for determining the number of particles contained in a liquid includes: using the particle capture filtration membrane according to the present invention; permeating the liquid through the particle capture filtration file from a side of the skin layer; and, after permeation of the liquid, counting the number of the particles present on a surface of the skin layer.

According to the above-described aspects, it is possible to obtain a particle capture filtration membrane that can be produced in high yield with the size of individual areas through which water can pass, for example, less than 10 nm at the topmost surface of the filtration surface, and by using this particle capture filtration membrane, the number of particles in a liquid can be easily measured.

### BRIEF DESCRIPTION OF DRAWINGS

FIG. 1A is a schematic cross-sectional view of a particle capture filtration membrane according to one embodiment.

FIG. 1B is a schematic plan view of the particle capture filtration membrane.

FIG. 1C is an enlarged cross-sectional view of the particle capture filtration membrane.

FIG. 2 is a view illustrating the definition of channel diameter.

FIG. 3 is a view showing the manufacturing process of the particle capture filtration membrane.

FIG. 4 is a view illustrating the method of measuring the number of particles.

FIG. 5 is a graph showing the relationship between the thickness of the skin layer and the channel diameter of the communication pores.

FIG. 6 is a graph showing the relationship between the concentration of particles and detection efficiency.

### DESCRIPTION OF EMBODIMENTS

Next, embodiments for implementing the present invention will be described with reference to the drawings.

As mentioned above, with regard to ultrapure water used in the manufacture of semiconductor devices, it is necessary to control the content of fine particles with a particle diameter of about 5 nm, for example. In the existing particle capture filtration membranes, it is difficult to make the pore diameter of the communication pore for liquid permeation 5 nm, for example, even when using an anodized aluminum film, which is said to be able to easily form through holes with a small pore diameter. On the other hand, particle capture filtration membranes with a pore diameter of 10 nm or greater for the communication pores at the filtration surface are readily fabricated and available. Therefore, the particle capture filtration membrane according one embodiment is made by narrowing the pore diameter of the communication pores on one surface of a base membrane, through which liquid-permeable communication pores are formed, so that the diameter of the communication pores on that surface is, for example, less than 10 nm, or as an example, 5 nm.

As the base membrane, any membrane with communication pores that allow liquid to permeate can be used, and the pore diameter can be narrowed in such a membrane using the method of the present embodiment. It is preferable that the base membrane is one of these membranes that can itself be used as a filtration membrane for capturing particles in liquids. As an example, particle capture filtration membranes obtained by anodic oxidation of aluminum material to form communication pores can be used as the base membrane, as shown in Patent Literatures 2 and 3. In particular, in the present embodiment, it is preferable to use as the base membrane a particle capture filtration membrane which is formed by anodic oxidation of aluminum material and has a pore diameter of 10 nm or more but 40 nm or less for the communication pores on the filtration surface side, and it is more preferable to use the filtration membrane with a pore diameter of 10 nm or more but 20 nm or less. As a method to reduce the pore diameter of the communication pores on the one surface of the base membrane, a skin layer can be deposited on that surface by a vapor deposition method. Since a vapor deposition method is used, the skin layer grows where the substrate material is present, and at the opening of the communication pore in the base membrane, the skin layer grows to narrow the pore diameter at that opening. As a result, formed on the base membrane is a skin layer with communication pores which connect to the communication pores of the base membrane and have a channel diameter smaller than a pore diameter of the communication pores of the base membrane. The definition of the channel diameter is discussed below.

The vapor-deposition methods can be broadly classified into physical vapor deposition (PVD) methods and chemical vapor deposition (CVD) methods. In the particle capture filtration membrane of the present embodiment, it is not necessary to deposit the skin layer deep into the communication pores of the base membrane, so it is preferable to use PVD methods, which have a lower processing temperature and do not require treatment of reaction products, etc. The PVD methods include, for example, vacuum evaporation, ion plating, and sputtering, and any of which can be used to produce particle capture filtration membranes. In order to uniformly reduce the pore diameter of the communication pores, when forming the skin layer by the PVD method, it is preferable to form the skin layer by conducting film formation multiple times while changing the orientation of the base membrane, with respect to the one surface of the base membrane. More specifically, it is preferable to form the skin layer by placing the base membrane parallel to the target surface in the film formation equipment by the PVD method, rotating the base membrane around an axis parallel to the thickness direction of the base membrane for each film deposition by the PVD method, and repeating this multiple times.

To measure the number of particles in a liquid using the particle capture filtration membrane prepared, the liquid is permeated through the filtration membrane from the skin layer side, and, after the permeation of the liquid, the surface of the skin layer is observed with a scanning electron microscope (hereinafter called SEM) to count the number of particles on the surface of the skin layer. Generally, when observing a sample surface with SEM, it is necessary to give conductivity to the sample by attaching conductive particles to the sample surface as a pretreatment. However, if conductive materials are used as materials constituting the skin layer, the pretreatment is not necessary before observation with SEM. Therefore, the material used for the skin layer is not particularly limited, but from the viewpoint of making pretreatment before observation by SEM unnecessary, for example, one metal selected from the group consisting of gold (Au), platinum (Pt), tungsten (W), silver (Ag), osmium (Os) and palladium (Pd), or an alloy of two or more metals included in this group is preferred to form the skin layer.

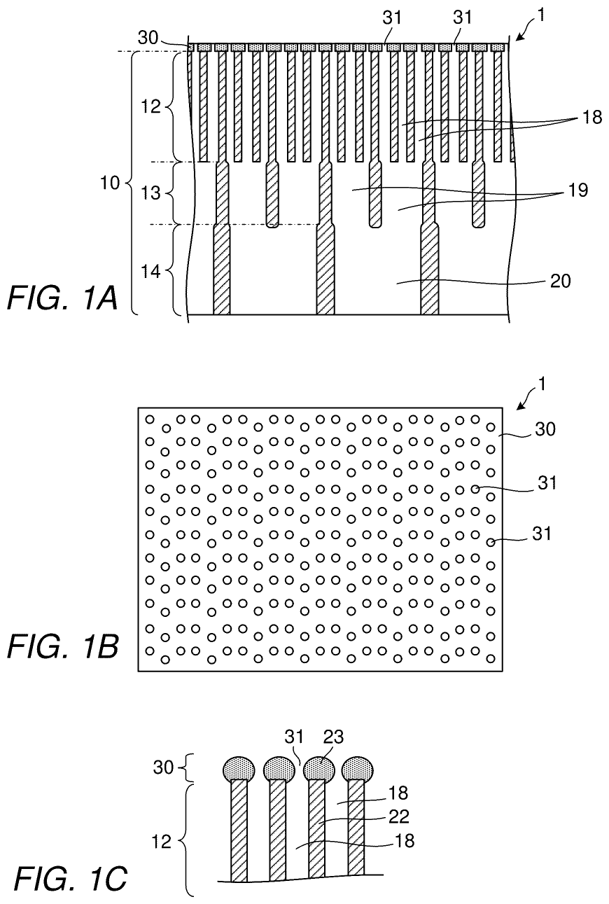

FIGS. 1A, 1B and 1C are a schematic cross-sectional view, a schematic plan view, and an enlarged cross-sectional view, respectively, of a particle capture filtration membrane according to an embodiment. As shown in FIG. 1A, skin layer 30 is formed on one surface of base membrane 10 in particle capture filtration membrane 1. FIG. 1C 1c shows an enlarged view of the boundary between base membrane 10 and skin layer 30.

Base membrane 10 is formed by anodic oxidation of aluminum (Al) material, which itself can be used as a particle capture filtration membrane with the one surface thereof as a filtration surface. Base membrane 10 is divided into three regions along its thickness direction from the side of the one surface: first region 12, which is the small pore diameter part; second region 13, which is the intermediate pore part; and third region 14, which is the large pore diameter part. In first region 12, communication pores 18, or first communication pore portions, opening on one surface of base membrane 10 are formed. In FIG. 1A, the shaded hatched areas indicate areas that are not the communication pores in the cross section of base membrane 10. In third region 14, communication pores 20, or third communication pore portions, that open to the other surface of base membrane 10 are formed. In second region 13, which is the region between first region 12 and third region 14, communication pores 19, or second communication pore portions, are formed. Communication pore 19 in second region 13 is connected at one end to communication pore 18 in first region 12 and at the other end to communication pore 20 in third region 14. Communication pore 18 in first region 12, communication pore 19 in second region 13, and communication pore 20 in third region 14 form a continuous communication pore from the one surface of base membrane 10 to the other surface.

The pore diameter of communication pore 18 at the opening at the one surface of base membrane 10 is, for example, 10 nm or more but 40 nm or less. The pore diameter of communication pore 19 in second region 13, which is connected to communication pore 18 in first region 12, is larger than the pore diameter of communication pore 18. Similarly, the pore diameter of communication pore 20 in third region 14, which connects to communication pore 19 in second region 13, is larger than the pore diameter of communication pore 19. The pore diameters of the communication pores in each region are larger the closer they are to the other surface of base membrane 10, and it can be said that base membrane 10 is a base membrane with a three-stage structure of communication pores. In the present embodiment, a plurality of communication pores 18 in first region 12 connect to one communication pore 19 in second region 13, and a plurality of communication pores 19 in second region 13 connect to one communication pore 20 in third region 14, so that as many communication pores 18 with a relatively small pore diameter as possible open on the one surface of base membrane 10. The membrane thickness of first region 12 is, for example, 400 nm or more but 1000 nm or less.

The skeletal part of base membrane 10 described here is obtained by anodizing aluminum material, followed by stripping the anodized portion from the aluminum material, followed by etching the surface, followed by burning. In FIG. 1A, the areas that are not communication pores are shaded with diagonal hatching. The shaded hatching indicates the skeletal part in base membrane 10, which is formed of aluminum oxide. The walls of each of communication pores 18, 19, 20 are also formed from aluminum oxide. Such base membrane 10 can be produced by the method described in Patent Literature 2 or Patent Literature 3, so a description of the production method of base membrane 10 is omitted here.

Skin layer 30 is formed on the one surface of base membrane 10 by PVD method and has communication pores 31. The thickness of skin layer 30 is, for example, 60 nm or less, and preferably 10 nm or more. Communication pores 31 in skin layer 30 are connected to communication pores 18 opening on the one surface of base membrane 10. At this time. communication pores 31 in skin layer 30 and communication pores 18 on base membrane 10 need only be connected as flow channels through which liquid (e.g., water) can permeate, and need not be formed in a straight line with each other. In the thickness direction of skin layer 30, the channel diameter of communication pore 31 in skin layer 30 has a smaller area than the pore diameter of communication pore 18 on base membrane 10 that is connected to communication pore 31. As an example, the channel diameter of communication pores 31 in skin layer 30 is less than 10 nm. Particle capture filtration membrane 1 thus configured can be used to capture microparticles contained in a liquid, with the surface on which skin layer 30 is provided as the filtration surface. FIG. 1B is a schematic plan view of particle capture filtration membrane 1 of the present embodiment viewed from its filtration surface, showing that skin layer 30 is exposed on the filtration surface and that a number of communication pores 31 are formed in skin layer 30. Since communication pores 31 in skin layer 30 are communicated with communication pores 18 to 20 in base membrane 10, a flow channel is formed in particle capture filtration membrane 1 that allows liquid to pass through from the one surface, or the filtration surface, to the other surface thereof.

In the present embodiment, the number of remaining particles, or blank particles, on the surface of skin layer 30 after completion of particle capture filtration membrane 1 is a factor that determines the amount of filtered water required when actually capturing the particles in a liquid (e.g., water) using particle capture filtration membrane 1. Since more particles than the number of blank particles must be captured on particle capture filtration membrane 1, a larger number of blank particles requires a longer flow time, or filtration time, to measure the number of particles in the liquid. From this perspective, in the present embodiment, the number of blank particles is preferably, for example, 4.9×10⁵ particles/cm² or less, and 1.6×10⁵ particles/cm² or less is more preferable.

FIG. 1C is an enlarged schematic cross-sectional view showing the boundary portion between base membrane 10 and skin layer 30 when skin layer 30 is formed by a sputtering method. As shown in the figure, wall portion 22 made of aluminum oxide is disposed between each other of adjacent communication pores 18 in base membrane 10, and particles 23 by the sputtering method are attached around the surface that is the top of wall portion 22 to form skin layer 30.

Next, the terms “pore diameter” and “channel diameter” used in the present embodiment will be explained. If the shape of the communication pore is an abbreviated circle, i.e., if the shape of the water-passing area is an abbreviated circle in cross section perpendicular to the water-passing direction, then the long diameter of the pore is the pore diameter. The communication pores formed by anodic oxidation of aluminum material are generally circular in shape and thus characterized by a “pore diameter” defined in this way. In contrast, when skin layer 30 is deposited on the surface of base membrane 10 by sputtering or other methods, the shape of communication pores 31 formed in skin layer 30 is not necessarily circular, but can be various shapes such as lines, cracks, and crevices. Since skin layer 30 constitutes the filtration surface that captures particles in particle capture filtration membrane 1, it can be said that communication pores 31 formed in skin layer 30 are flow channels that allow water to flow in the thickness direction without allowing the particles larger than a predetermined particle diameter to permeate. Whether certain particles are allowed to pass through or not depends on the size of the individual areas of water flow at the top surface of skin layer 30, which is the filtration surface. Therefore, in the present description, the size of the individual areas of water flow on the topmost surface of the filtration surface is referred to as the “channel diameter.”

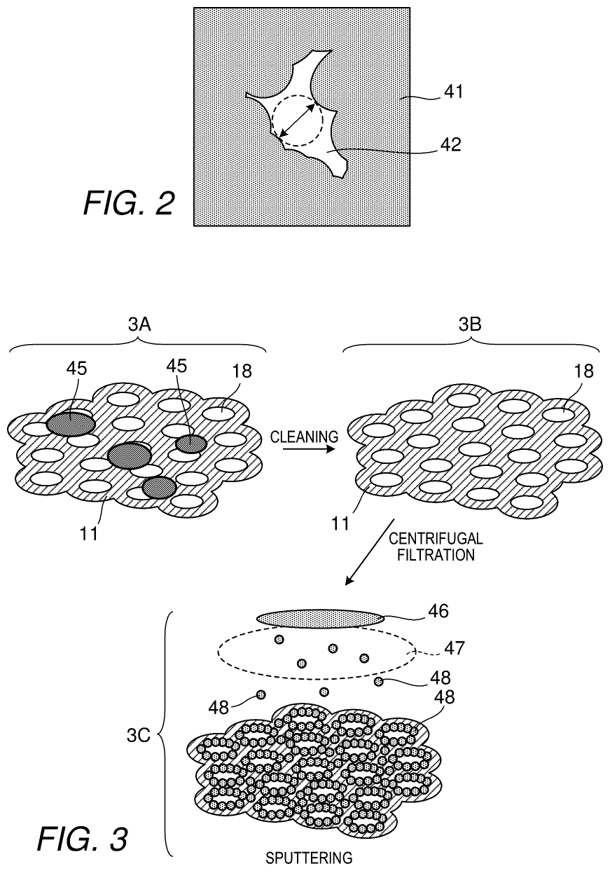

FIG. 2 is a view showing the definition of the term “channel diameter” as used in the present embodiment. In the figure, dotted portion 41 is a portion in skin layer 30 where sputtering particles and the like have deposited and water is not allowed to pass through. There, as communication pore 31, region 42 is formed as a flow channel that extends in a direction perpendicular to the drawing sheet and allows water to pass through. As shown in FIG. 2, if the shape of region 42 that allows water to pass through at the top surface of skin layer 30 is not circular, the channel diameter is the longest diameter in a plane perpendicular to the direction of water passage, in region 42 that allows water to pass through. This can also be said to be the diameter of the circle with the largest radius inscribed in the water-passing region. On the other hand, if the shape of region 42 at the top surface of skin layer 30 through which water can pass is roughly circular, the “channel diameter” is its longest diameter of region 42, similar to the “pore diameter” described above.

Next, the manufacturing method of particle capture filtration membrane 1 in the present embodiment is explained using FIG. 3. First, base membrane 10 is prepared as indicated by sign 3A in the figure. Particles 45 are adhered to surface 11 of base membrane 10. In FIG. 3, base membrane 10 is not shown by its overall shape, but by surface 11 of base membrane 10. Base membrane 10 is then cleaned to remove particles 45 adhering to surface 11 of base membrane 10. Sign 3B shows surface 11 of base membrane 10 after cleaning. This cleaning is performed, for example, by ultrasonic cleaning. When cleaning base membrane 10 by ultrasonic cleaning, hydrogen gas is dissolved in and alkaline chemicals are added to ultrapure water to make functional water, which is then heated, and ultrasonic vibration is applied to the functional water while base membrane 10 is immersed in the heated functional water. Ammonia (NH₃) can be used as the alkali chemical, for example. By cleaning surface 11 of base membrane 10 before forming skin layer 30 by PVD, blank particles can be effectively reduced. When cleaning was performed after the formation of skin layer 30 to remove blank particles, peeling of skin layer 30 was observed, as described below.

After cleaning, base membrane 10 is desiccated. After desiccation, particles are adhered to the one surface 11 of base membrane 10 by the PVD method to form skin layer 30. Here, the sputtering method is described as a PVD technique to attach sputtering particles to base membrane 10, but other PVD techniques such as vacuum evaporation and ion plating may also be used.

When forming skin layer 30 by the sputtering method, base membrane 10 is placed in sputtering equipment and sputtering is performed on base membrane 10 to form mask layer 30 on the one surface 11 of base membrane 10, as indicated by sign 3C in the figure. When plasma 47 is generated between target 46 and base membrane 10, ions from plasma 47 collide with target 46, and atoms 48 of the target material are ejected from target 46, which collide with and deposit on surface 11 of base membrane 10, forming skin layer 30. By using the sputtering method, skin layer 30 is formed so that the pore diameter of communication pore 18 opening on the one surface 11 of base membrane 10 is substantially reduced by communication pore 31 of skin layer 30. In sputtering, the one surface 11 of base membrane 10 is placed parallel to the surface of target 46 of the sputtering material, and base membrane 10 is sputtered multiple times while changing the orientation of base membrane 10 relative to target 46 by rotating base membrane 10 on an axis perpendicular to its surface. By conducting sputtering multiple times while changing the orientation of base membrane 10 in the plane parallel to the surface of base membrane 10, it is possible to uniformly form skin layer 30 and uniformly reduce the pore diameter of the communication pores.

Particle capture filtration membrane 1 according to the present embodiment is completed through the process described above. According to the method described above, particle capture filtration membrane 1 can be obtained in which the number of remaining particles (i.e., blank particles) on the surface of skin layer 30 (i.e., the filtration surface) at the time of completion is reduced compared to filtration membranes obtained by forming skin layer 30 without cleaning of base membrane 10 or by conducting cleaning after formation of skin layer 30 on the surface of the base membrane 10.

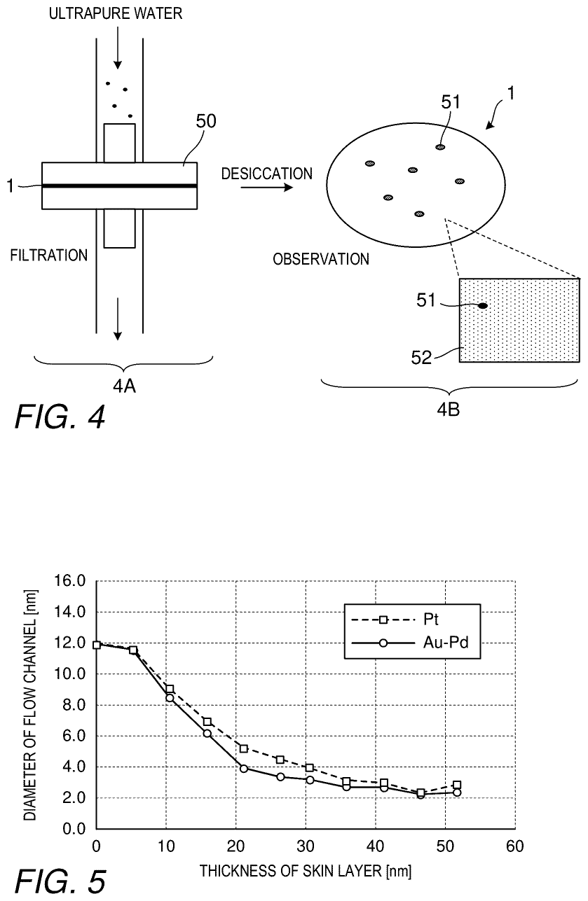

Next, the measurement of the number of particles in a liquid using particle capture filtration membrane 1 according to the present embodiment is explained using FIG. 4. Let us assume that the liquid to be measured is ultrapure water. As indicated by sign 4A in FIG. 4, particle capture filtration membrane 1 is removably attached to filtration device 50, and ultrapure water is filtered through particle capture filtration membrane 1 so that ultrapure water passes through particle capture filtration membrane 1 from the side of skin layer 30 side. It is preferable to use a centrifugal filtration device as filtration device 50.

After a predetermined amount of ultrapure water has permeated through particle capture filtration membrane 1, particle capture filtration membrane 1 is detached from filtration device 50 and desiccated, and then placed in an observation device such as an SEM, as shown in sign 4B. The surface of skin layer 30, or the filtration surface, of particle capture filtration membrane 1 is observed by the observation device. The number of particles 51 captured in observed image 52 is then counted. Particle counting may be done by visual counting of the observed image or by software image processing of the observed image. Since the particles having a particle diameter greater than the channel diameter of communication pores 31 of skin layer 30 cannot pass through particle capture filtration membrane 1, it is possible to calculate, according to the following formula, how much ultrapure water contains particles 51 with a particle diameter larger than the channel diameter of communication pores 31 of skin layer 30, based on the filtration area of particle capture filtration membrane 1 at the time of filtration, the amount of ultrapure water filtered, the area of the observation field of view, and the number of particles 51 in the observation field of view.

$$Particle counts [ particles / L ] = \frac{Detected counts [ particles ] \times Filtration area [ {mm}^{2} ]}{\begin{matrix}Area of observation field of view [ {mm}^{2} ] \times \\ Amount of filtered water [ L ]\end{matrix}}$$

For example, if the channel diameter of communication pores 31 in skin layer 30 is 5 nm, it is possible to determine how much of the ultrapure water contained fine particles with a particle diameter greater than 5 nm. Since blank particles, i.e., particles that already exist on the surface of skin layer 30 before filtration of ultrapure water, are also detected as particles in the observation field of view, it is preferable that the number of blank particles is determined by observing the surface of skin layer 30 of particle capture filter membrane 1 before filtration, and then the number of particles in ultrapure water is calculated based on the value obtained by subtracting the number of the blank particles from the number of the particles observed after filtration. When the observation device is an SEM, a composition analysis of what elements the particles consist of can also be performed by measuring the energy of characteristic X-rays or Auger electrons generated from the particles present on the filtration surface during observation.

### EXAMPLES

Next, the present invention will be explained in more detail based on Examples. In the following Examples, the measurement of the number of particles on the surface of base membrane 10 or on the surface of particle capture filtration membrane 1 was conducted based on the direct inspection method described in JIS (Japanese Industrial Standard) K 0554-1995 (“Method for measuring particles in ultrapure water”) using SEM.

### Example 1

Particle capture filtration membrane 1 based on the embodiment described above was prepared. Base membrane 10 was prepared and used as described using FIGS. 1A, 1B, and 1C, where the average pore diameter of communication pores 18 opening on the one surface of base membrane 10 was 12 nm. After ultrasonic cleaning of base membrane 10, skin layer 30 was formed by sputtering. We investigated how the channel diameter of communication pores 31 in skin layer 30 changes with the thickness of skin layer 30 when platinum (Pt) was used and gold (Au)-palladium (Pd) (6:4) alloys was used as the target material. Sputtering was performed multiple times while changing the orientation of base membrane 10 with respect to target 46, and the deposited thickness of skin layer 30 in one sputtering operation was 5.3 nm. The results are shown in FIG. 5. From FIG. 5, the thickness of skin layer 30 with a channel diameter of 5 nm for communication pores 31 formed in skin layer 30 was 30 nm when platinum was sputtered and 20 nm when a gold-palladium alloy was used. When the thickness of skin layer 30 is less than 5.3 nm, it was found that the effect of substantially reducing the pore diameter of the communication pores opening on the filtration surface is small.

### Example 2

The effect of cleaning of base membrane 10 was investigated. As in Example 1, base membrane 10 with an average pore diameter of 12 nm for communication pores 18 opening on the one surface was prepared and ultrasonically cleaned as described above, and the number of blank particles on the surface of base membrane 10 was 1.6×10⁵ particles/cm² on average. When skin layer 30 with a thickness of 30 nm was formed by sputtering platinum onto the same base membrane 10, followed by ultrasonic cleaning, the number of blank particles on the surface of skin layer 30 was 1.6×10⁶ particles/cm² on average. On the other hand, when the same base membrane 10 was cleaned and then skin layer 30 was formed by sputtering, the average number of blank particles on the surface of skin layer 30 was 4.9×10⁵ particles/cm². It was found that when skin layer 30 was formed by sputtering on the filtration surface of base membrane 10 after ultrasonic cleaning of base membrane 10, the number of blank particles could be maintained or reduced to the same level as the base membrane 10. On the other hand, when ultrasonic cleaning was performed after the formation of skin layer 30, more blank particles were produced. In addition, when ultrasonic cleaning was performed after skin layer 30 was formed, peeling of skin layer 30 was also observed.

### Example 3

Particle capture filtration membrane 1 was prepared as in Example 1, and the surface of skin layer 30 was observed by SEM before and after centrifugal filtration of ultrapure water. The channel diameter of communication pores in skin layer 30 was 5 nm. Observations showed no significant change in the surface condition of skin layer 30 before and after centrifugal filtration, indicating that centrifugal filtration using particle capture filtration membrane 1 of the present embodiment described above has no impact on the filtration membrane.

Furthermore, the number of filtration days required to measure the number of particles at the same lower limit of quantitation was examined for the use of particle capture filtration membrane 1 in Example 3 and for the use of the filtration membrane in Comparative Example, where base membrane 10 itself is used as the particle capture filtration membrane. The filtration membrane in Comparison Example has a pore diameter of 5 nm for communication pores 18 that open on the filtration surface of base membrane 10, and does not have a skin layer. It was found that by using particle capture filtration membrane 1 of Example 3, the number of filtration days could be reduced to about one-third compared to using the filtration membrane of Comparative Example. This is because the length of the section with a pore or channel diameter of 5 nm in the communication pores along the thickness direction is shorter in the particle capture filtration membrane of Example 3 than in the particle capture filtration membrane of Comparative Example, which is thought to be due to the smaller water flow resistance in the particle capture filtration membrane of Example 3. In particle capture filtration membrane 1 based on the embodiment described above, if the channel diameter of the communication pores on the topmost surface of the filtration surface is 10 nm or less, for example, and the channel diameter of the communication pores at other locations along the thickness direction is larger than 10 nm, the water flow resistance can be further reduced and the required days for filtration can be shortened even further.

### Example 4

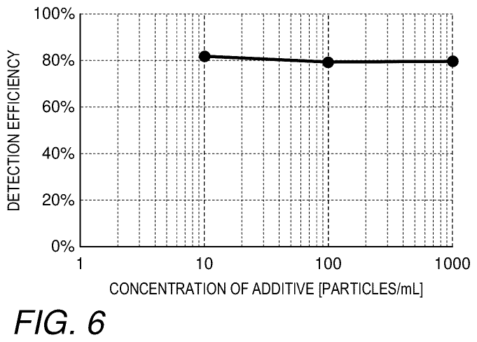

The detection efficiency was determined when the number of particles in ultrapure water was measured using particle capture filtration membrane 1 based on the embodiment described above. Particle capture filtration membrane 1 was prepared with a channel diameter of 5 nm for communication pores 31 in skin layer 30. As the sample water, ultrapure water to which gold (Au) particles having a particle diameter of 5 nm were added was used. The sample water was then permeated through particle capture filtration membrane 1, and the number of gold particles on skin layer 30 was then counted by SEM observation. The detection efficiency (%) was calculated from the number of gold particles added to the sample water, or the number of added particles, based on the following formula. The results are shown in FIG. 6.

$$Detection efficiency = \frac{Detected counts [ particles ] \times Filtration area [ {mm}^{2} ]}{Area of observation field of view [ {mm}^{2} ]} \times \frac{1}{Amount of filtered water [ L ]} \times \frac{1}{Number of added particles [ particles / L ]}$$

A detection efficiency of more than 80% was achieved regardless of the concentration of gold particles added. The detection efficiency of 80% or higher is satisfactory because particle capture filtration membrane 1 based on the present invention is used to measure the number of particles with a small diameter and low concentration, which are difficult to measure with an on-line instrument by a method such as light scattering method.

### Reference Signs List

1 Particle capture filtration membrane;
10 Base membrane;
12 First region;
13 Second region;
14 Third region;
18 to 20, 31 Communication pores; and
30 Skin layer.

1. A particle capture filtration membrane with a communication pore that allows liquid to permeate through, comprising:
a base membrane with a first communication pore; and
a skin layer which is formed on one surface of the base membrane and in which a second communication pore is formed,
wherein the second communication pore is connected to the first communication pore, and
wherein a channel diameter of the second communication pore is smaller than a pore diameter of the first communication pore that is connected to the second communication pore.

2. The particle capture filtration membrane according to claim 1, wherein the channel diameter of the second communication pore is less than 10 nm.

3. The particle capture filtration membrane according to claim 1, wherein a thickness of the skin layer is 10 nm or more.

4. The particle capture filtration membrane according to claim 1, wherein number of particles remaining on a surface of the skin layer is 1.6×10⁶ particles/cm² or less.

5. The particle capture filtration membrane according to claim 1,
wherein the skin layer is formed by one metal selected from a group consisting of gold, platinum, tungsten, silver, osmium and palladium, or an alloy of two or more metals contained in the group, and
wherein the base membrane is an anodic oxide film of aluminum.

6. The particle capture filtration membrane according to claim 1,
wherein the base membrane is configured in a multistage structure with, along with a thickness direction of the base membrane, a first region where a first communication pore portion opening on the one surface of the skin layer is formed, a second region where a second communication pore portion connecting to the first communication pore portion is formed, and a third region where a third communication pore portion connecting to the second communication pore portion and opening on the other surface of the skin layer, a pore diameter of the second communication pore portion being larger than a pore diameter of the first communication pore portion and a pore diameter of the third communication pore portion being larger than the pore diameter of the second communication pore portion, and
wherein the first communication pore is formed of the first communication pore portion, the second communication pore portion, and the third communication portion.

7. A manufacturing method of a particle capture filtration membrane with a communication pore allowing liquid to permeate through, comprising:
forming a skin layer by physical vapor deposition on one surface of a base membrane with a first communication pore,
wherein the skin layer is equipped with a second communication pore that is connected to the first communication pore, and
a channel diameter of the second communication pore is smaller than a pore diameter of the first communication pore that is connected to the second communication pore.

8. The manufacturing method of the particle capture filtration membrane according to claim 7, wherein the skin layer is formed by performing physical vapor deposition multiple times while changing orientation of the base membrane in equipment used for physical vapor deposition.

9. A measurement method for determining number of particles contained in a liquid, comprising: using the particle capture filtration membrane according to claim 1 to permeate the liquid through the particle capture filtration membrane from a side of the skin layer; and, after permeation of the liquid, counting number of the particles present on a surface of the skin layer.

10. The measuring method according to claim 9, comprising:
counting, before the permeation of the liquid, number of the particles present on the surface of the skin layer; and
subtracting the number of the particles counted before the permeation of the liquid from the number of the particles counted after the permeation of the liquid, and calculating the number of the particles contained in the liquid based on a value obtained by the subtraction.
